(19) United States
(12) Patent Application Publication
(10) Pub. No.: US 2004/0017324 A1
(43) Pub. Date: Jan. 29, 2004

(54) Metallic, self-similar interior shield for facilitating connection of a low noise amplifier inside a non-planar, multiarm log-periodic antenna

(76) Inventor: Gregory Engargiola, Berkeley, CA (US)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 09/963,888

(22) Filed: Sep. 19, 2001

(51) Int. Cl. H01Q 11/10

(52) U.S. Cl. 343/792.5

(57) ABSTRACT

A non-planar log-periodic antenna feed with low ohmic loss, intermediate gain multioctave bandwidth, and dual polarization can be integrated with a low-noise MMIC amplifier, at ambient or cryogenic temperatures. Long, lossy transmission lines with nearly 1 dB loss, normally required for connecting log-periodic antennas to microwave signal detection circuits, are unnecessary in this design. Amplifiers are positioned close to the antenna terminals at the vertex of the antenna, inside a square pyramidal shield with half the opening angle of the antenna arms. The non-obvious idea is that a conductor enclosing a large volume of self-similar shape between the antenna arms enhances gain while preserving the frequency-independence of the log-periodic antenna over its operating bandwidth. The design has been reduced to practice. A 1-10 GHz prototype has been range tested. A small microwave telescope which incorporates this feed can achieve over multioctave bandwidths an A/T (sensitivity) that is unprecedented. Simple construction and low cost of manufacture make it ideal for use in telescope arrays.

### CROSS REFERENCE TO RELATED APPLICATIONS

Not applicable

### BACKGROUND DESCRIPTION OF PRIOR ART

According to Rumsey (“Frequency Independent Antennas,” V. H. Rumsey, Academic Press: N.Y. 1966), only an antenna of infinite extent, with a shape specified entirely by angles, can be truly frequency independent. Such shapes are self-similar on all size scales and radiate circularly polarized beams. Indeed, the first antennas to show broadband performance were the planar and conical equiangular spiral designs of Dyson, which meet Rumsey's angular criteria over a limited range of scales.

Another kind of antenna which approximates frequency independence has a form which can be specified by two or more angles, a scale factor, and two dimensions. The form results from chaining together elements of similar shape in a geometric progression of size. The dimensions of the smallest and largest element determine the response bandwidth. Radiation arises from a resonant region where adjacent elements behave approximately like an backfire array of switched, half-wave dipoles. Such antennas have electrical and radiation properties which vary periodically with the logarithm of frequency. When the scale factor and the unit cell shape, defined by angles, can be set to make this variation tolerably small, the resulting log-periodic antenna can be regarded as frequency independent over its response bandwidth.

The simple geometry of the self-similar planar switched dipole array is useful for illustrating the general operation of a log-periodic antenna (FIG. 5.15, Rumsey). Dipoles are alternately connected to opposite sides of a two-wire transmission line, called a feeder. Signal terminals are connected to the feeder at the small dipole end. When the antenna transmits, RF energy at the operating frequency propagates away from the terminals in the direction of increasing size elements to the “active region” where the dipoles have the correct electric lengths and phases to radiate. Small dipoles near the input are electrically very close and generate fields nearly 180 degrees out of phase, which mostly cancel. As the RF energy travels along the feed it encounters larger dipoles of increasing separation. Eventually, it reaches a region on the antenna where the dipoles are phased for backfire radiation. If the dipoles in this region have electrical lengths of approximately one half wavelength of the applied signal (the resonance condition) they will generate a beam directed back toward the smaller, non-resonant elements. In a properly designed dipole array antenna, radiation attenuates the feeder mode by more than 20 dB as it passes through the active region. If the structure parameters aren't properly tuned, a large fraction of the RF energy will escape past the active region and be reflected back from the wide end of the dipole array. This increases the VSWR of the feeder and enhances the rearward lobe of the radiation pattern, thus increasing the variation of impedance and beamshape over a log period of frequency. While a nearly unipolar far-field pattern with high gain and linear polarization can be achieved with a planar dipole array, the 3 dB contour of the main lobe is elliptical, making it inefficient for illuminating reflectors which are surfaces of rotation.

DuHamel and Isbell fabricated the earliest log-periodic antennas from stiff sheet metal. After some trial and error they devised the pattern shown in FIG. 5.4 (Rumsey). This pattern is specified by two angles, a scale factor, and two radial lengths. The antenna can be realized as two separate metal pieces or two slots in an extended metal sheet. If the rays bounding the antenna elements subtend 90 degrees, the geometry is self complementary. Mushiake was the first to show that in this case, the terminal impedance will be frequency independent and equal to ˜180 Ohms. The radial extent of the antenna, R, and the angle subtended by the flat-top radial teeth, a, set the minimum frequency of operation. Increasing R or the angle alpha decreases the minimum frequency. The radius of the gap separating the arms, r, to which terminals are attached, determines the maximum frequency of operation—the terminal separation measured in wavelengths must be small over the entire bandwidth. From the symmetry of the antenna it is clear that the far-field pattern is bipolar. This is inconvenient for receiving directional signals. While one of the beams can be terminated with absorber, the maximum directivity of this planar antenna is 9 dB. Also, if the termination is not cooled, the lowest receiver temperature achievable is 150 C.

Isbell demonstrated that if the two arms of this antenna are inclined to form a wedge (FIG. 5.6, Rumsey), the gain of one lobe increases at the expense of the other. When the opening angle of the wedge is reduced to less than 50 degrees, the antenna pattern is effectively unipolar, with the main lobe pointing in the direction of decreasing antenna size. Variations on this non-planar log-periodic design were evolved with straight rather than curved conductor edges. Periodically self-similar patterns composed of symmetric trapezoidal or sawtooth waveforms played a key role in early theoretical and experimental studies of frequency independent antennas. FIG. 5.9 (Rumsey) shows the basic geometry of these structures. As is true for a planar dipole array, all angles, linear dimensions, and scale factors which specify a non-planar LP antenna critically influences how the far-field pattern and impedance vary over a log period.

Precisely how a non-planar log-periodic antenna works can be inferred from the near field measurements of Bell, Elfving, and Franks for a triangular-tooth LP antenna (FIG. 5.12 Rumsey). Using polarization information, they separated out a slow wave “transmission line” mode emanating from the antenna vertex and a radiation mode emanating from an active region of resonant structure cells. Analogous to a two-wire line, E-fields for the transmission line mode are polarized roughly linearly between the two conductors. Fields for the radiation mode are polarized along the direction of the triangular teeth. The amplitude and phase distributions for these modes are depicted schematically in FIG. 5.11 (Rumsey). Where the slope of a phase curve changes sign marks the origin of a mode. The radiation mode origin (the phase center of the antenna) is located in the active cell region, approximately a wavelength from the vertex; its precise location depends on the opening angle of the antenna. The voltage amplitude of the radiated wave attenuates only slightly as it passes the vertex into the far-field. In the opposite direction, the radiation amplitude falls off rapidly. Clearly, this is an endfire antenna. The slope of the phase curve indicates a phase velocity in both directions. For the transmission line mode, the voltage amplitude decays rapidly in front of the antenna. Here, the phase velocity is c, but between the conducting arms, the phase velocity decreases to ⅔ c. This indicates that the transmission line region, capacitively loaded by triangular teeth dipoles, supports a slow wave mode; here, the 1/r dependence of the voltage amplitude arises from diverging antenna arms. Radiation heavily attenuates the slow wave mode as it propagates through the active region. These results can be generalized to any pyramidal LP antenna.

From the above it is clear that, relative to the wedge geometry of a log-periodic antenna, there are distinct electromagnetic fields, inside and out. Inside: the transmission line mode, which conducts signals from the narrow end, where balanced antenna terminals are located. Outside: the radiation mode or radiation response pattern. In order to connect microwave energy into or out of the terminals, (depending on whether one is broadcasting or receiving with the antenna), a balanced transmission line must be attached to the terminals. Since transmission lines are conductors, they can disrupt the radiation or transmission modes of the antenna if not attached with care. There are distinct disadvantages to the current transmission line attachments to non-planar log periodic antennas.

a) Transmission lines attached to the antenna LP terminals are attached along the mid-line of one of the antenna arms and brought out the back (wide end) of the antenna, where the radiation and transmission modes are very weak. Here, the lines are attached to an amplifier receiver or transmitter. Significant attenuation of the applied (received) signal occurs. This loss is significant, as high as 1 dB before the signal can be amplified.

b) Receiver/Transmitter electronics must be kept separate from The log-periodic antenna structure. For reasons of space economy it may be useful to integrate an amplifier directly into the antenna. However, any electronic module placed between the antenna arms (inside the wedge geometry) close to the antenna terminals will disrupt the transmission mode feeding the active region of the antenna structure.

Summary: In accordance with the present invention, a square metal pyramidal shield, on axis and interior to the wedge geometry of the a log-periodic antenna, with an opening angle equal to half the opening angle (or less) of the antenna arms (the wedge opening angle), will enhance the gain of a log-periodic antenna while preserving the frequency independence: said antenna with said shield incorporated will have roughly constant impedance and radiation response pattern over its band of operation.

### OBJECTS AND ADVANTAGES

a) An electronics module for transmitting(Tx) or receiving (Rx) can be placed inside said pyramidal shield without disrupting transmission or radiation modes of said log-periodic antenna, whereby said module can be brought very close to said antenna terminals, obviating the need for long lossy transmission line cables the length of the antenna. Instead, a section of transmission line much shorter than the antenna length is needed to make the antenna terminal-electronics module connection.

b) Said pyramidal shield can be the outer vacuum jacket of a compact cryostat, whereby cryogenically cooled, low-noise Microwave Monolithic Integrated Circuit (MMIC) amplifiers can be attached through short, therefore low-loss, leads to the antenna terminals. Such an integrated antenna/amplifier combination would afford unprecedented signal sensitivity over multi-octave bandwidths.

c) Said pyramidal shield increases the gain of the antenna significantly. For an antenna with opening angle 20 degrees, and shield with opening angle 10 degrees, the main lobe gain is approximately 1.3 dB higher than what one expects if the shield were not present.

### FURTHER OBJECTS AND ADVANTAGES

Said pyramidal shield can be placed, on axis and interior, to dual log-periodic antennas, sharing a common axis and vertex, rotated at right angles to each other in order to transmit or receive two orthogonal polarization modes. Indeed, the figures collectively depict assembly of a dual polarization log-periodic antenna with square pyramidal shield.

### DRAWING FIGURES

FIG. 1 Shows the pattern of a single arm of a triangular tooth non-planar log-periodic antenna. The pattern is formed by assembling similar shapes (triangles in this case), where adjacent shape elements differ in linear scale by a constant scale factor. For the case shown, the scale factor is 0.975. The width (transverse to the centerline) of the smallest triangular element pair at the narrow end determines the shortest wavelength of the operating bandwidth. The width (transverse to the centerline) of the largest triangular element pair determines the longest wavelength of the operating bandwidth.

FIG. 2 Shows the orientation of two arms comprising a non-planar log-periodic antenna capable of detecting one polarization. The direction of the main radiation lobe is in the direction of decreasing element size. The polarization direction is along the direction of the triangular teeth. The two arms are inclined at the same angle τ as the opening angle of a single antenna arm. That is, the antenna volume can be enclosed by a square pyramid, truncated at the tip.

FIG. 3 Shows how two non-planar log-periodic antenna can be brought together at right angles on a common axis to make a four terminal antenna (two balanced-signal terminal pairs), capable of receiving or transmitting orthogonally polarized radiation.

FIG. 4 The pyramidal metallic shield. Its opening angle is 1/2τ, one half (or can be less) the opening angle of said dual-polarized non-planar log-periodic antenna.

FIG. 5 The shield shown on-axis, interior to, said dual-polarized non-planar log-periodic antenna.

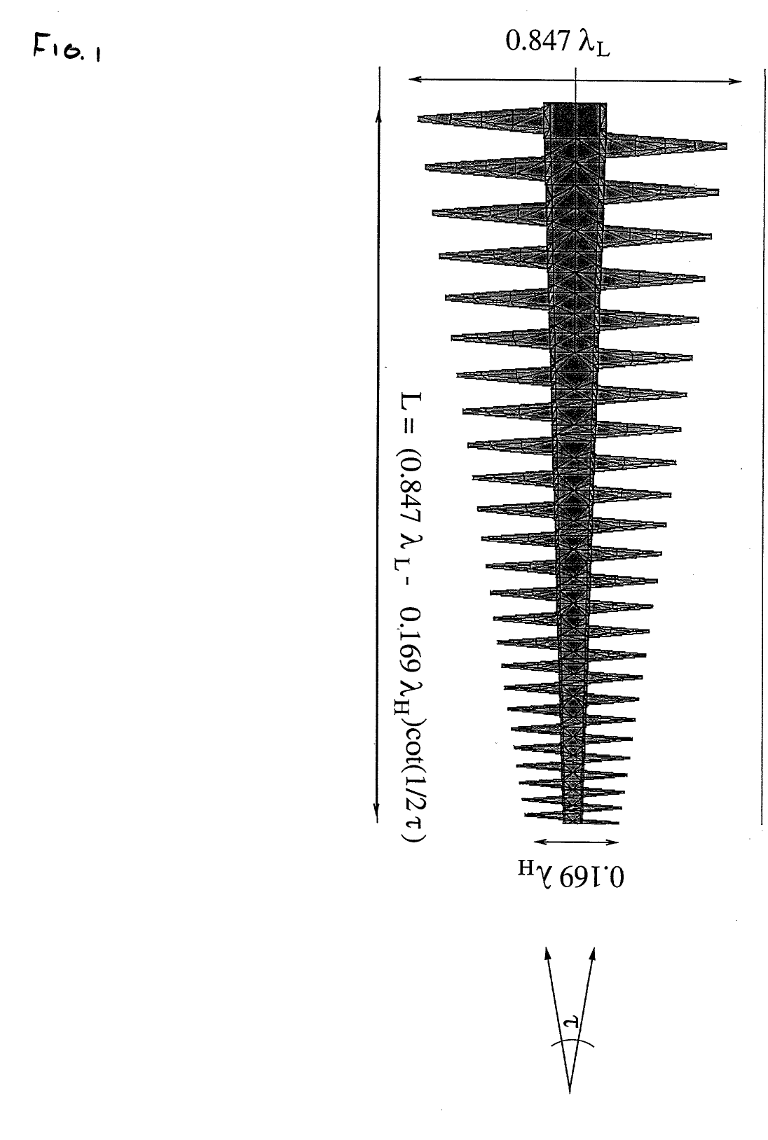

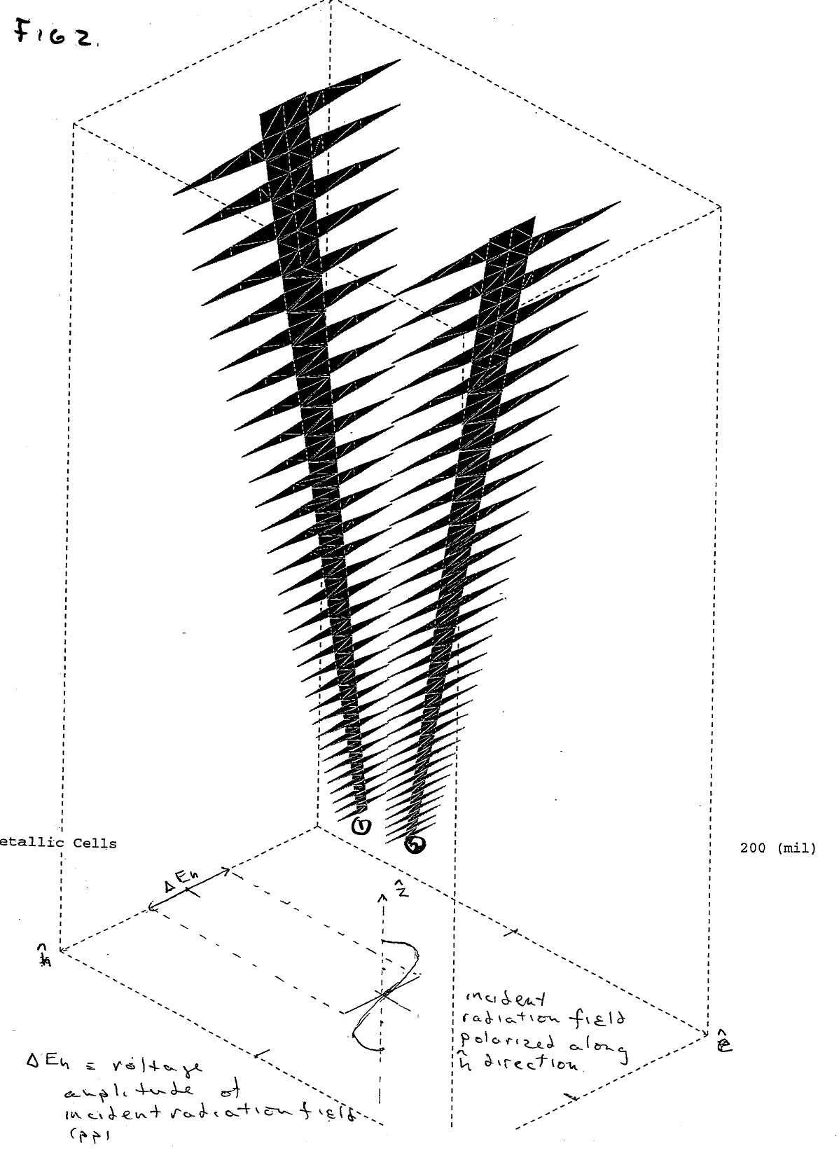

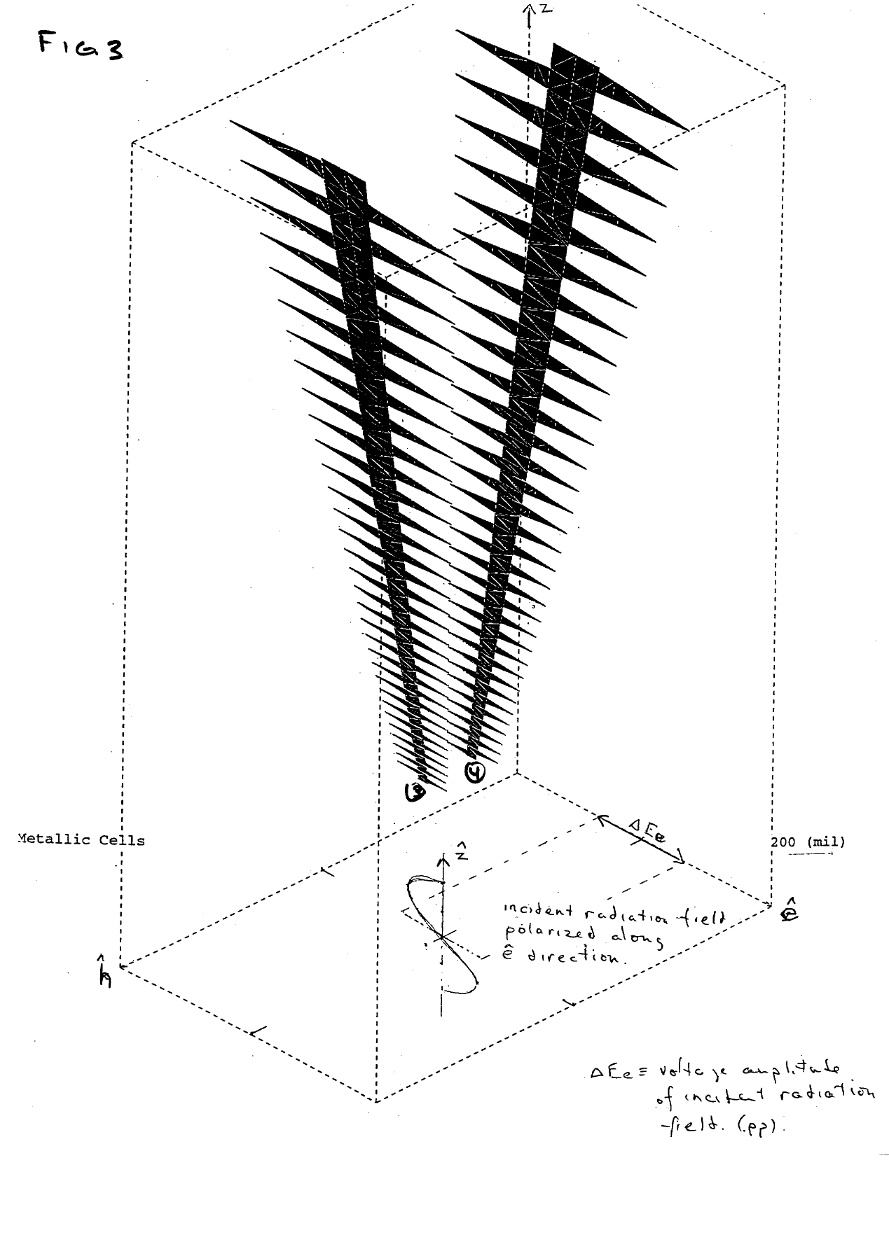

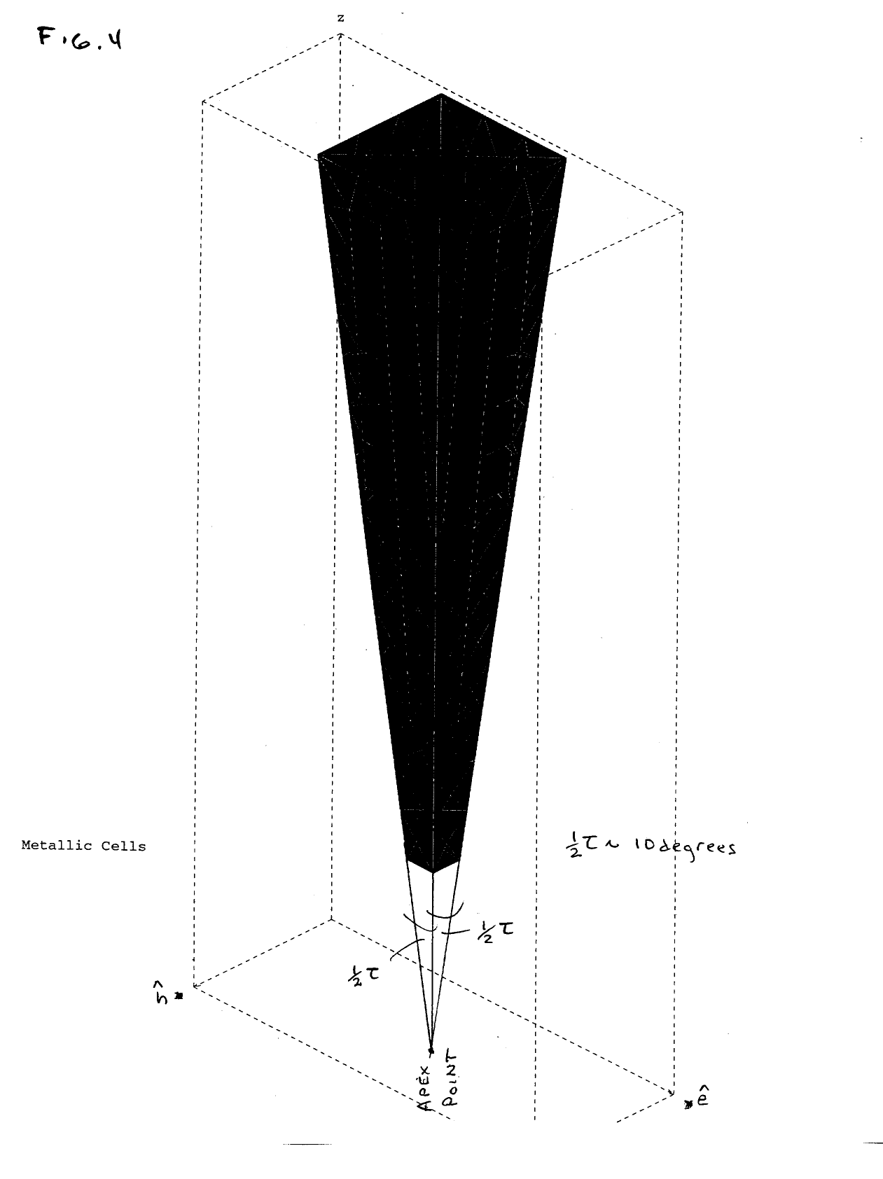

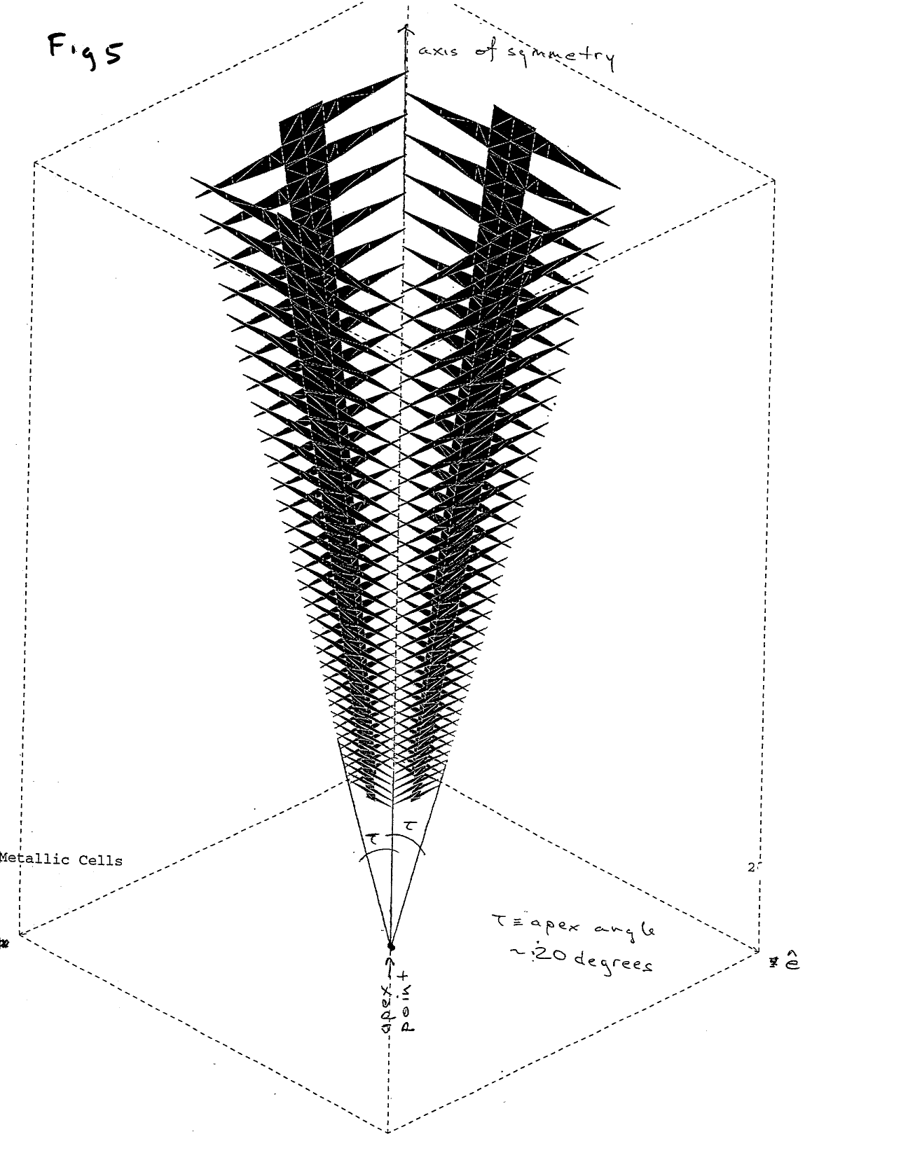

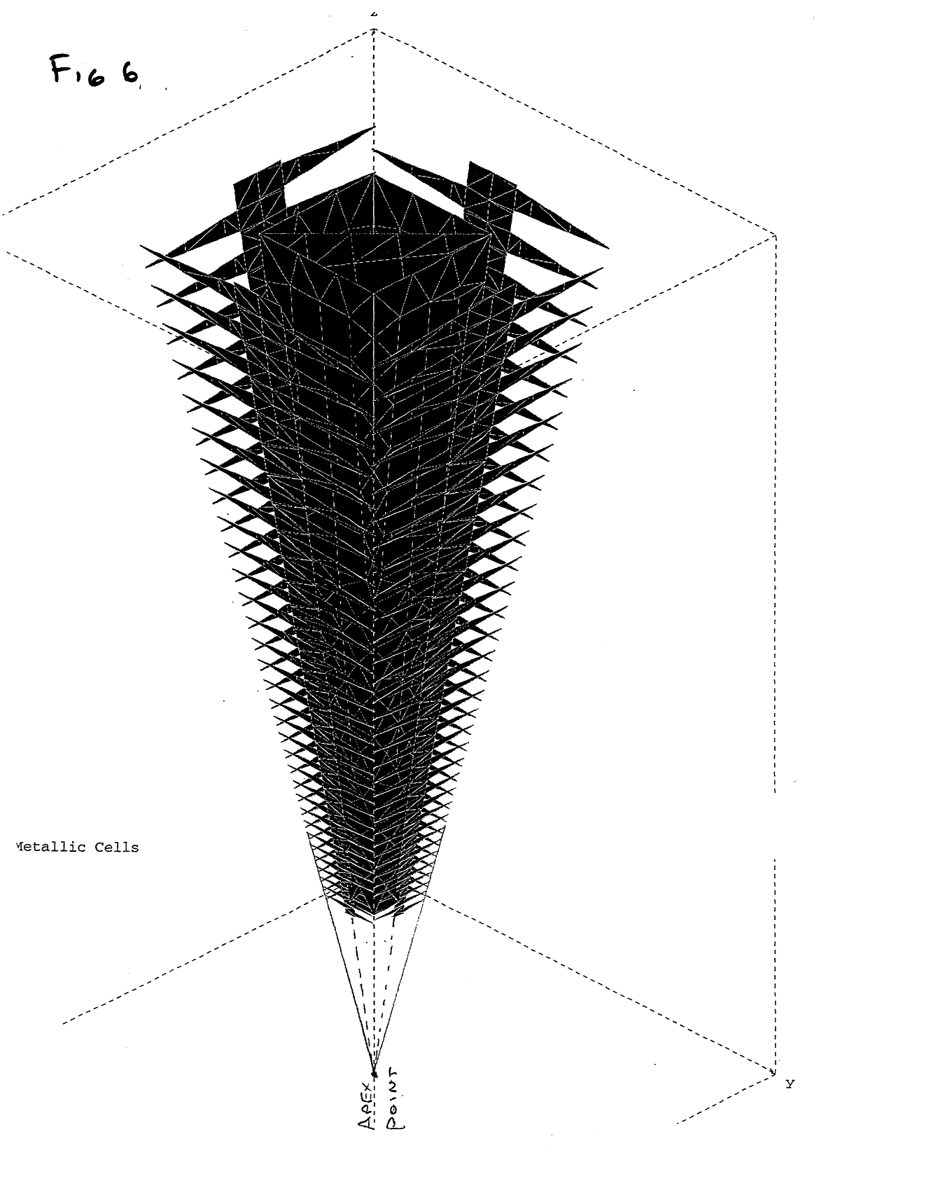

### REFERENCE NUMERALS IN DRAWINGS

1. point of attachment for one of two balanced terminals

2. point of attachment for second of two balanced terminals

3. point of attachment for one of two balanced terminals

4. point of attachment for second of two balanced terminals

(1,2)=polarization mode h

(3,4)=polarization mode e

### Preferred Embodiment

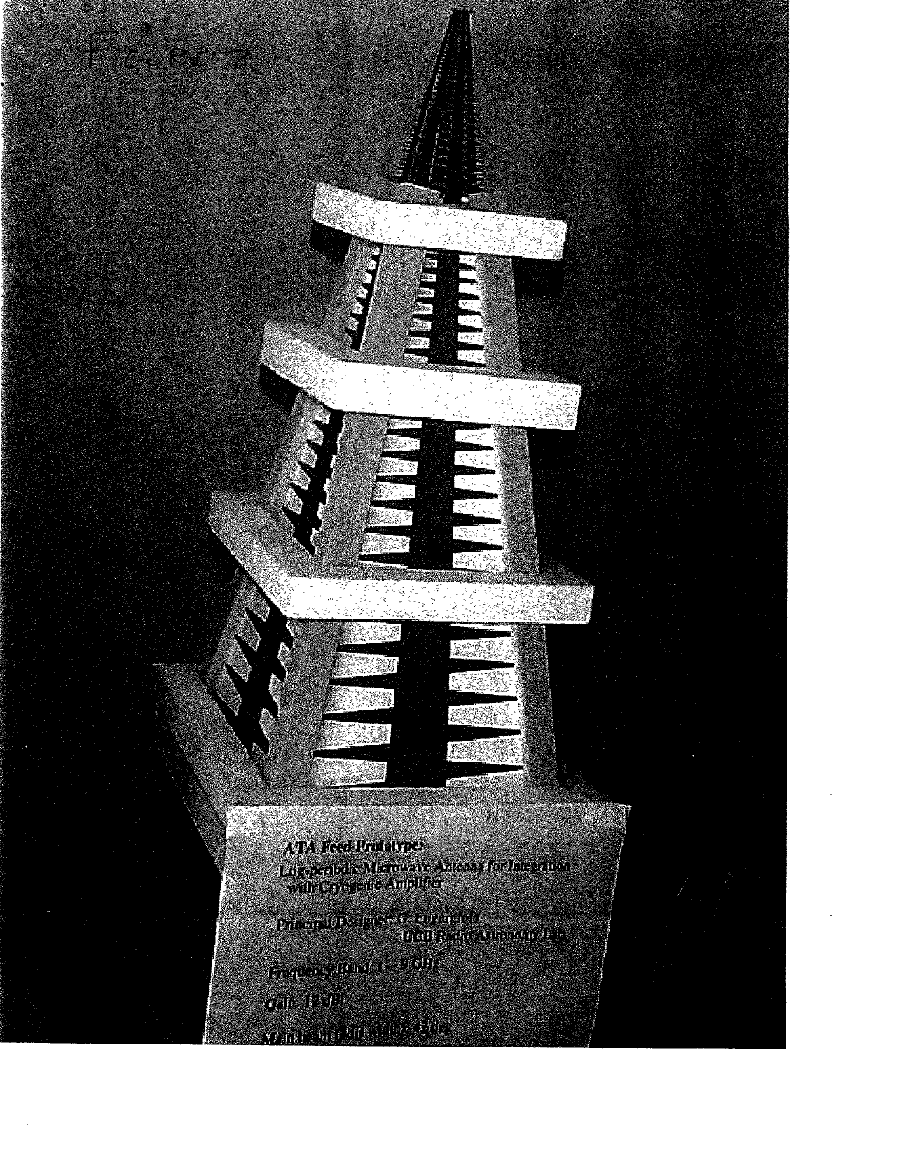

A preferred embodiment of the present invention is shown in FIG. 5. The arms of the antenna can be supported on a Styrofoam mandrel (not shown) with an on-axis hole into which the pyramidal shield can be inserted. The mandrel acts as both a spacer and support. Alternatively, the antenna arms can be directly attached to the face of the pyramidal shield using Teflon support spacers and nylon screws, where the attachments are made along the centerline of each antenna arm and as few spacers as possible are used to insure the rigidity of the antenna/shield combination yet at the same time minimize disruption of the transmission line mode of the antenna.

### Advantages

From the description above, the advantages of the metal pyramidal shield in non-planar log-periodic antenna are clear. In particular, a low-noise MMIC can be directly integrated with a log-periodic antenna structure allowing for low-noise detection of microwave signals over multioctave bandwidths. Long, lossy transmission lines with nearly 1 dB of loss, normally required for connecting log-periodic antennas to microwave signal detection circuits, are unnecessary in this design. Amplifiers or other electronic signal transmission or detection devices can be positioned close to the antenna terminals at the vertex of the antenna, whereby they are connected by short, low-loss leads (balanced transmission lines) which exit the narrow end of the shield and attach via a circuit board or wire connections to the antenna arms. Without the shield, strong fields inside the antenna might cause the electronic devices to oscillate if not placed in a proper grounded conducting module. The shield in effect is such a module; because of its geometry it preserves the self-similar geometry of the antenna, whereby, it turns out, the antenna can still operate in a frequency independent manner over a bandwidth determined by the largest and smallest feature sizes on the antenna. Because of the pyramidal shields size, it can be made big enough to enclose compact cryogenics. The result can be used as a cryogenic front end for coupling and amplifying the focal fields of a microwave dish antenna over multioctave bandwidths, allowing one to achieve a high ratio of dish area to receiver noise temperature which is unprecedented.

I claim:

1. In a non-planar log-periodic antenna of type comprising two radiator arms oriented about a common axis with and enclosing a square pyramidal conductor with truncated tip,

2. Said antenna wherein the arms are composed of low ohmic loss metal.

3. Said antenna wherein arms are identical log-periodic shapes, inclined by less than 30 degrees to each other, oriented to have 180 degree symmetry about the said common axis.

4. Said square pyramidal conductor made of low loss metal.

5. Said square pyramidal conductor wherein axis of pyramid and said antenna arm pair are common.

6. Said square pyramidal conductor wherein opening angle of same is one half or less inclination angle of said antenna arms.

7. Said square pyramidal conductor wherein same has identical projected extent along common axis as said antenna.

8. Combination of said two antenna arms with said shield in the interior wherein the entire structure behaves a log-periodic antenna

9. The non-planar log-periodic antenna of type comprising four radiator arms oriented about a common axis and enclosing a square pyramidal conductor with truncated tip.

10. The said combination wherein a short wire is attached to the narrow end of each said antenna arm, at an endpoint of the said antenna arm centerline, and threaded into the said square pyramidal conductor through said truncated tip of the said square pyramidal conductor.

11. The said antenna wherein the square pyramidal conductor is enclosed on four sides by four identical log-periodic antenna arms.

12. Combination as in manner of previous claims of said four antenna arms with said pyramidal conducting shield in the interior wherein the entire structure behaves as a log-periodic antenna.

13. The said combination wherein a short wire is attached to the narrow end of each said antenna arm, at an endpoint of the said antenna arm centerline, and threaded into the said square pyramidal conductor through said truncated tip of the said square pyramidal conductor.
